(19) United States
(12) Patent Application Publication
(10) Pub. No.: US 2016/0280055 A1
(43) Pub. Date: Sep. 29, 2016

(54) MOTOR VEHICLE DRIVE DEVICE

(71) Applicants: Richard CHENE, Neuilly (FR); Alain MIKLITARIAN, Paris (FR); Olivier RODI, Gambais (FR); Dominique DELAMOUR, Les Mesnuls (FR); SOCIETE ALBIGEOISE DE FABRICATION ET REPARATION AUTOMOBILE - SAFRA, Albi (FR)

(72) Inventor: Dominique Delamour, Dominique (FR)

(21) Appl. No.: 15/030,028

(22) PCT Filed: Oct. 8, 2014
(86) PCT No.: PCT/EP2014/071484

§ 371 Date: Apr. 15, 2016

(30) Foreign Application Priority Data
Oct. 18, 2013 (FR) 13600168

(51) Int. Cl. B60K 6/00; B60K 17/04

(52) U.S. Cl. CPC B60K 6/00; B60K 17/04; B60Y 2200/143; B62D 47/02

(57) ABSTRACT

A drive device for a transportation motor vehicle having at least one hydraulic drive module and one primary electric drive module, a coupling unit and an output shaft that is suitable for being driven by the hydraulic drive module and/or the primary electric drive module via the coupling unit. The hydraulic drive module and the primary electric drive module can be directly connected to the coupling unit. The drive device can further include a backup energy module directly connected to the hydraulic motor module.

### GENERAL TECHNICAL FIELD AND PRIOR ART

The present invention relates to the field of vehicles, in particular for the transport of goods or people. A transport vehicle also refers to an individual car or collective vehicle of the bus type. It is moreover for this application that the applicant wished to resolve the problem at the origin of the invention of this application.

Ordinarily, a transportation bus comprises one or more sets of wheels that are rotated by an intermediate drive device, for example, a transmission shaft, a bridge and/or an axle. The energy provided by the drive device allows the movement of the transportation bus.

In order to optimize the energy consumption of the drive device, a drive device has already been proposed comprising different energy sources. Known in the prior art, from patent application FR 2,971,742, is a transportation vehicle comprising a drive device comprising a thermal drive module, a hydraulic drive module and an electric drive module. Subsequently, such a drive device is described as “tri-hybrid”.

In a known manner, the drive device comprises a coupling unit comprising a thermal module input shaft, a hydraulic module input shaft and an electric module input shaft, and an output appropriate for driving a motor shaft.

In practice, such a coupling unit has a large bulk and a significant complexity, which is detrimental to the architecture of the motor vehicle. In particular, each input shaft of the coupling unit must be precisely aligned with the appropriate drive module to drive it. Furthermore, it is necessary to connect the shaft of the thermal drive module precisely with the coupling unit, which makes the assembly and maintenance operation more complex.

Furthermore, a coupling unit with three input shafts requires using a large number of pinions. Due to its bulk, such a coupling unit decreases the available volume within a transportation vehicle, which is a drawback.

Lastly, the bulk and weight of a coupling unit are significant, given that it must be robust to withstand vibrations generated by the thermal drive module.

Lastly, the thermal drive module belongs to the primary traction chain of the vehicle, and it is necessary, due to the regulatory constraints, to use a high-capacity heat engine, in particular, a heat engine for a heavy truck having a high mass and bulk. Such a heat engine thus has many drawbacks.

### SUMMARY

The invention therefore aims to resolve these drawbacks by proposing a drive device that is compact, has a simple design and offers great reliability.

The invention originally was born to resolve a problem related to a heat engine, but it applies more generally to any drive device comprising several drive modules.

To that end, the invention relates to a drive device for a transportation motor vehicle comprising at least one hydraulic drive module and one primary electric drive module, a coupling unit and an output shaft that is suitable for being driven by the hydraulic drive module and/or the primary electric drive module via said coupling unit, the hydraulic drive module and the primary electric drive module being directly connected to said coupling unit.

The invention is remarkable in that the drive device further comprises an energy supply module directly connected to the hydraulic drive module. In other words, the energy supply module is not directly connected to the coupling unit. An energy supply module refers to any module appropriate for providing energy to the hydraulic drive module, in particular a heat engine, a fuel cell, etc. Preferably, the energy supply module has a simple design and is not suitable for being recharged during the operation of the vehicle. Preferably, the energy supply module is configured to convert a non-regenerative energy into hydraulic energy. Preferably, the energy supply module is independent from the drive modules.

The use of an energy supply module that is separate from the coupling unit makes it possible to select the energy supply module that is most appropriate based on the vehicle and its usage location. Thus, the energy supply module can use gas, diesel, hydrogen, ethanol. The flexibility offered by the drive device according to the invention is thus advantageous.

Preferably, the hydraulic drive module comprises at least a hydraulic motor and a hydraulic reservoir suitable for supplying said hydraulic motor, and the energy supply module is suitable for recharging said hydraulic reservoir.

The drive device according to the invention has a coupling unit with a reduced bulk given that it is not directly connected to the energy supply module. In fact, it is not necessary to provide a pinion to connect to the energy supply module in the coupling unit. The hydraulic drive module and the primary electric drive module are traction modules of the vehicle, while the energy supply module only forms an energy reserve suitable for converting the energy into a hydraulic pressure.

By analogy with the aeronautic field, the energy supply module can perform a support function similar to that of an auxiliary power device known by those skilled in the aeronautic field under the name APU (Auxiliary Power Unit) or an autonomy extending function known by one skilled in the art as a “range extender”.

Preferably, the energy supply module is connected to the hydraulic drive module by a hydrostatic link. Such a hydrostatic link has the advantage of being flexible, which improves the compactness of the drive device. Furthermore, a hydrostatic link makes it possible to do away with a mechanical link, which has a shorter lifetime and is more complex to maintain. Thus, the vibrations of the energy supply module are not transmitted to the hydraulic drive module, which is advantageous.

Advantageously, the hydrostatic link comprises a first fluid aspiration channel and a second fluid return channel that are connected to the hydraulic drive module as well as a mechanical compression member, driven by said energy supply module, mounted between the first fluid aspiration channel and the second fluid return channel. Thus, the energy supply module makes it possible to compress the fluid coming from the hydraulic drive module in order to give it an auxiliary energy.

According to one preferred aspect of the invention, the coupling unit comprises a first gear line, a second gear line, connected to the output shaft, and a connecting means able to associate the two gear lines. Such a coupling unit has a simple design, which makes it possible to decrease its manufacturing cost.

Preferably, the coupling unit is made up of a first gear line, a second gear line, connected to the output shaft, and a connecting means able to associate the two gear lines. In other words, the coupling unit may comprise only a limited number of gear lines as well as a limited number of connecting means.

Also preferably, each gear line comprises a plurality of pinions. A gear line with no planetary gears has an improved lifetime and limited bulk.

Preferably, the hydraulic drive module is connected to the first gear line and the primary electric drive module is connected to the second gear line. Thus, the connecting means make it possible to choose between the different energy sources to drive the vehicle.

Advantageously, the drive device comprises an auxiliary electric drive module, connected to the first gear line. Thus, the auxiliary electric drive module makes it possible to power the equipment of the vehicle (air conditioning, etc.). Furthermore, the auxiliary electric drive module also makes it possible to provide energy to the hydraulic drive module so that the latter replenishes its reserves.

According to another aspect of the invention, the auxiliary electric drive module and hydraulic drive module are connected to the same pinion of the first gear line in order to optimize the recharging performance of the hydraulic drive module by the auxiliary electric drive module.

Preferably, the auxiliary electric drive module comprising a generator, the hydraulic drive module is configured to drive said generator.

In one particular embodiment, the first gear line comprises at least two pinions, preferably three pinions. A first gear line comprising three pinions advantageously makes it possible to mount the hydraulic drive module at a distance from the appropriate pinion to connect with the second gear line.

The use of an intermediate pinion makes it possible to limit the size of the other pinions of the first gear line, which decreases the overall bulk of the coupling unit as well is its weight. Preferably, the first gear line only comprises three pinions.

According to another aspect of the invention, the second gear line comprises at least two pinions so as on the one hand to allow the connection to the first gear line, and on the other hand to allow the connection to the output shaft. Preferably, the second gear line only comprises two pinions.

The invention also relates to a motor vehicle, preferably of the bus type, comprising at least one set of wheels and a drive device, as previously described, to drive said set of wheels.

Preferably, the vehicle comprises a primary body and an auxiliary body removable from the primary body, the energy supply module being mounted in said auxiliary body.

Preferably, the energy supply module is a thermal drive module. Preferably, the fuel of the thermal drive module is gasoline, diesel, hydrogen or methanol.

The thermal drive module is easy to install and maintain given that there is no longer a need to align a motor shaft of the thermal drive module with a pinion of the coupling unit. Owing to the invention, the thermal drive module can be placed and oriented without constraints, which makes it possible to increase the compactness of the drive device.

A mechanical energy supply from the thermal drive module toward the coupling unit is advantageously avoided, the mechanical energy of the thermal drive module being transmitted directly to the hydraulic drive module. Thus, the vibrations of the thermal drive module are not transmitted to the coupling unit, which is advantageous.

Advantageously, the thermal drive module does not constitute part of the primary traction chain of the vehicle. The thermal drive module behaves as an auxiliary energy source appropriate for supplying the hydraulic drive module if needed. Thus, the thermal drive module having a secondary back-up role, it can have a simple design, which makes it possible to reduce the mass, bulk and cost.

### BRIEF DESCRIPTION OF THE FIGURES

The invention will be better understood upon reading the following description, provided solely as an example, and in reference to the appended drawings, in which:

FIG. 1 is a diagrammatic side illustration of a transportation bus according to the invention;

FIG. 2 is a functional diagrammatic illustration of one embodiment of the drive device according to the invention with a coupling unit connected to a plurality of drive modules; and

FIG. 3 is a structural diagrammatic illustration of one embodiment of the coupling unit of the drive device according to the invention.

### DETAILED DESCRIPTION

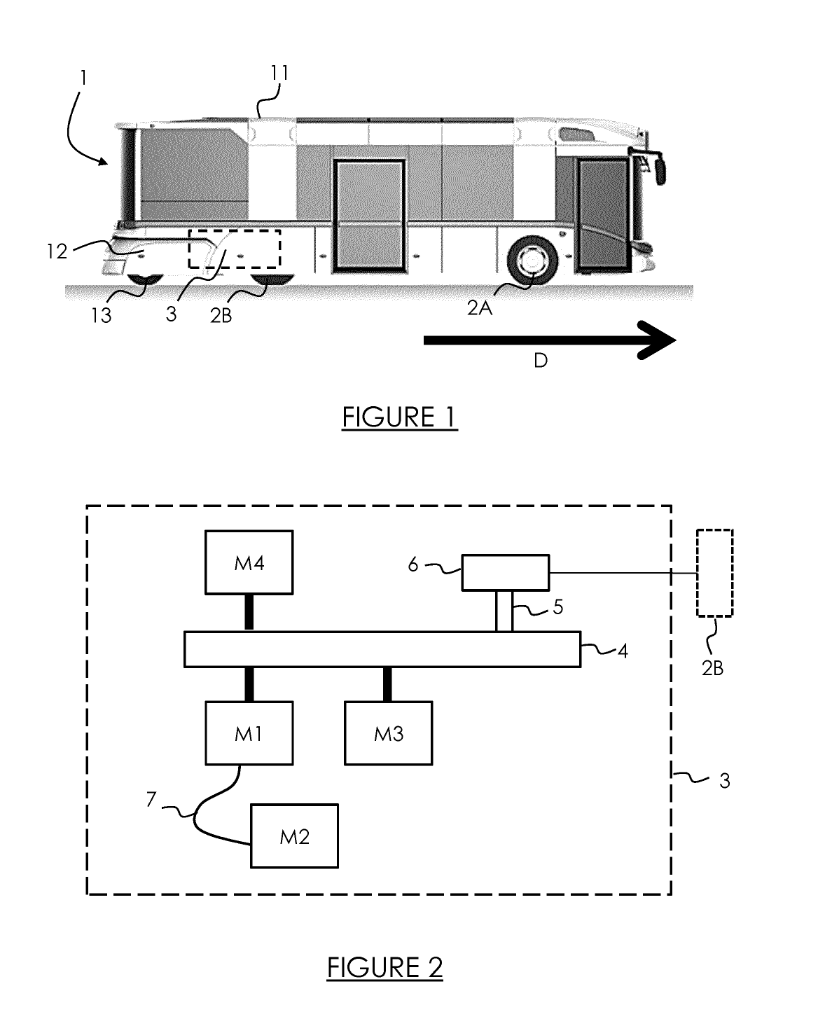

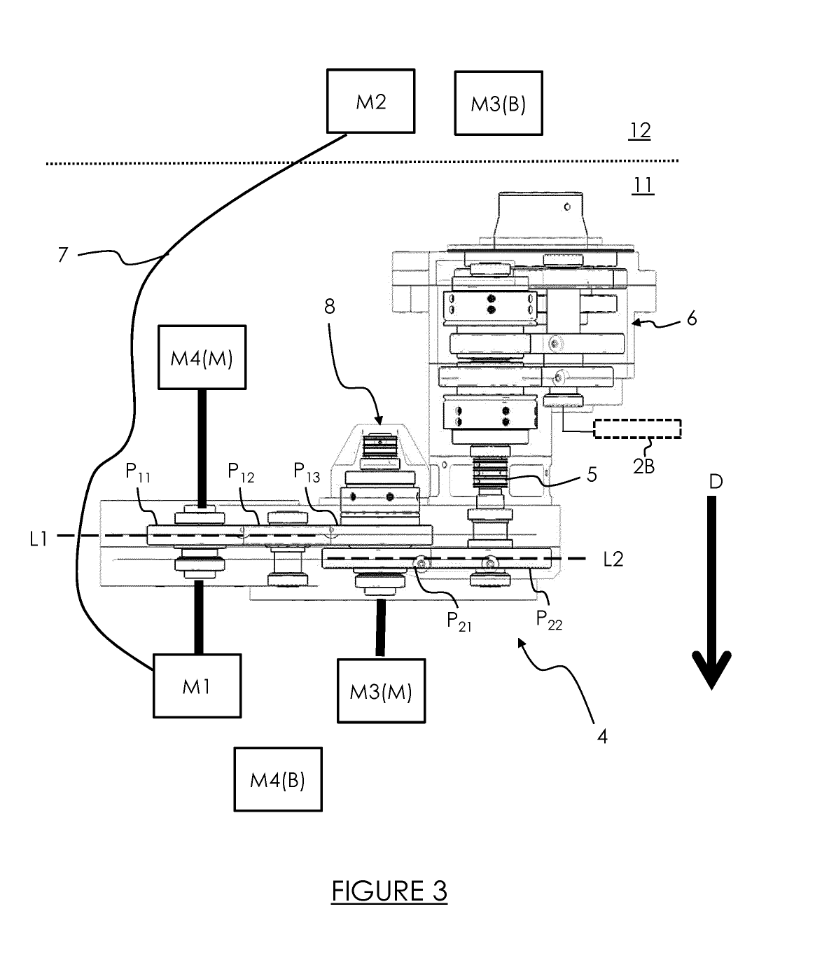

In reference to FIG. 1, a transportation bus 1 is shown comprising a primary body 11 defining at least one living area for passengers. The primary body 11 is equipped with a front set of wheels 2A and a rear set of wheels 2B to allow the bus to move, in particular on a road. Hereinafter, the terms “front” and “rear” are defined relative to arrow D shown in FIGS. 1 and 3 to indicate the typical movement direction of the transportation bus 1 from back to front.

In this embodiment, the transportation bus 1 further comprises an auxiliary body 12, also called “energy pack”, that is mounted removably relative to the primary body 11. Preferably, the auxiliary energy storage body 12 is equipped with wheels 13 in order to allow its manipulation when it is separated from the primary body 11 of the transportation bus 1.

As illustrated in FIG. 1, the transportation bus 1 comprises a drive device 3, shown diagrammatically, that is mechanically connected here to the rear set of wheels 2B in order to provide it with the energy allowing it to move. In a known manner, the driving energy is provided to the rear wheels 2B by means of a transmission shaft, a bridge and/or an axle.

In reference to FIG. 2, the drive device 3 comprises a hydraulic drive module M1, a primary electric drive module M3 and an auxiliary electric drive module M4 that are connected to a coupling unit 4 comprising an output shaft 5. In this example, the output shaft 5 is connected to the rear set of wheels 2B by a gearbox 6 known by those skilled in the art. The drive device 3 further comprises an energy supply module M2 that in this example assumes the form of a thermal drive module M2, but of course a fuel cell could also be appropriate.

The output shaft 5 of the coupling unit 4 is suitable for delivering output torque to the gearbox 6 from energy provided directly or indirectly by the modules M1-M4 that will now be described.

The hydraulic drive module M1 comprises a hydraulic motor, a hydraulic pump and a hydraulic reservoir that is suitable for supplying said hydraulic motor. Such a hydraulic drive module M1 is known as such from application FR 2,971,742. In this preferred embodiment, the hydraulic reservoir assumes the form of two pressurized oil canisters, preferably one high-pressure canister and one low-pressure canister. The hydraulic drive module M1 is connected directly to the coupling unit 4 in order to allow it to provide or receive an engine torque. This example describes a hydraulic drive module M1 in which the hydraulic motor and hydraulic pump are associated, but of course the invention applies similarly to a hydraulic drive module M1 in which the hydraulic motor and the hydraulic pump are separate, the main point being that the hydraulic drive module M1 can provide and receive energy.

The thermal drive module M2 in turn comprises a heat engine, preferably a motor vehicle heat engine, and a fuel tank in order to supply said heat engine. As will be outlined below, the heat engine is not connected directly to the coupling unit 4, but indirectly via the hydraulic drive module M1.

The primary electric drive module M3 comprises a primary electric motor M3(M) (FIG. 3) associated with a generator and a primary electricity storage battery M3(B) (FIG. 3), the voltage of which is, in this example, 450 V. Similarly to the hydraulic drive module M1, the primary electric drive module M3 is directly connected to the coupling unit 4 in order to provide it with engine torque or receive engine torque from it.

The auxiliary electric drive module M4 comprises an auxiliary electric motor M4(M) (FIG. 3) powered by an auxiliary electric battery M4(B) (FIG. 3), the voltage of which is 450 V in this example. Preferably, the auxiliary electric drive module M4 also comprises a generator. Similarly, the auxiliary electric drive module M4 is directly connected to the coupling unit 4 in order to provide it with motor torque or receive motor torque from it. The auxiliary electric motor means M4 makes it possible to recharge the electric battery M4(B) on which the equipment of the transportation bus 1 is connected, in particular the air-conditioning of said transportation bus 1. In this preferred embodiment, the auxiliary electric battery M4(B) has a lower capacity than the primary electric battery M3(B).

The coupling unit 4 makes it possible to couple the energy of the drive modules M1, M3, M4 in order to provide energy to the output shaft 5, the thermal drive module M2 forming an auxiliary energy source usable by the hydraulic drive module M1. Of course, other drive modules could be coupled to the coupling unit, in particular a kinetic energy drive module of the flywheel type.

According to the invention, the thermal drive module M2 is directly connected to the hydraulic drive module M1. In other words, the coupling unit 4 is not directly connected to the thermal drive module M2, which makes it possible to decrease the complexity of the coupling unit 4 and thus to decrease its bulk and manufacturing cost.

Preferably, the thermal drive module M2 is directly connected to the hydraulic drive module M1 by a hydrostatic link 7. Such a hydrostatic link 7 is flexible, which makes it possible to eliminate the alignment constraints related to a physical shaft. Furthermore, a hydrostatic link 7 is advantageous, since it makes it possible to obtain a variable speed, control a variable torque and maintain a constant power. Furthermore, the vibrational forces are not transmitted to the hydraulic drive module M1 and the coupling unit 4. The bulk and mass of the coupling unit 4 can thus be decreased.

In this embodiment, the hydrostatic link 7 assumes the form of a flexible hose comprising a pressurized fluid, preferably oil. The hydrostatic link 7 comprises mechanical members (hydraulic pump, etc.) that convert the mechanical energy provided by the thermal drive module M2 into hydraulic pressure for the hydraulic drive module M1. In particular, the hydrostatic link 7 comprises a hydraulic pump that withdraws liquid from the hydraulic reservoir of the hydraulic drive module M1, via a first so-called aspiration channel, to compress it and drive the hydraulic motor of the hydraulic drive module M1 via a second so-called return channel.

Preferably, each channel comprises a coupler so as to disconnect the hydrostatic link 7. Such couplers are advantageous to allow the separation of the auxiliary energy storage body 12 from the primary body 11 of the transportation bus 1.

In other words, the thermal drive module M2 provides energy to the coupling unit 4 via the hydraulic drive module M1.

Architecture of the Drive Device 3

In reference to FIG. 3, the thermal drive module M2 and the primary storage battery M3(B) are preferably mounted in the auxiliary energy storage body 12, while the coupling unit 4 is mounted in the primary body 11 with the hydraulic drive module M1 and the auxiliary electric drive module M4.

Thus, in case of failure of the thermal drive module M2 or the primary storage battery M3(B), the latter parts can be replaced quickly and practically by replacing a defective auxiliary energy storage body 12 with a new auxiliary energy storage body 12. Owing to the architecture of the drive device 3, the drive modules are housed optimally in the auxiliary energy storage body 12, which limits its bulk.

Furthermore, the vibrations relative to the thermal drive module M2 are absorbed by the auxiliary energy storage body 12, i.e., the energy pack, and are not transmitted to the primary body 11, which is suitable for receiving passengers. Passenger comfort on the transportation bus 1 is thus improved.

Advantageously, the connection between the primary body 11 and the auxiliary body 12 is simple. The thermal drive module M2 can easily be separated from the hydraulic drive module M1 by disconnecting the hydrostatic link 7, for example, using the couplers previously described. Likewise, regarding the primary electric drive module M3, the battery M3(B) can easily be separated from the electric motor M3(M). Advantageously, it is possible to recharge the battery M3(B) by separating the auxiliary energy storage body 12 from the primary body 11 in order to place the battery in a dedicated recharging zone.

The auxiliary electric drive module M4 is in turn mounted in the primary body 11. The auxiliary electric drive module M4, also called generator, makes it possible to recharge the hydraulic drive module M1. In other usage configurations, the auxiliary electric drive module M4 is recharged by the hydraulic drive module M1 with or without assistance from the thermal drive module M2.

The structure of the coupling unit 4 will now be described in detail.

Structure of the Coupling Unit

In reference to FIG. 3, the coupling unit 4 comprises a first gear line L1, a second gear line L2 and a connecting element 8 able to couple the two gear lines L1, L2, extending parallel to one another.

Each gear line L1, L2 comprises a plurality of simple pinions, without planetary gears, which increases the reliability of the coupling unit 4 and decreases the complexity, bulk and maintenance costs thereof.

Preferably, the gear lines L1, L2 are parallel and extend orthogonally to the direction in which the transportation bus 1 moves. In this embodiment, the first gear line L1 is situated behind the second gear line L2, as illustrated in FIG. 3.

Ordinarily, a pinion comprises a central body mounted on a rotating shaft and an outer toothing suitable for cooperating with the toothing of another pinion in order to transmit rotational torque to it. A pinion gear being known by those skilled in the art, the general operation will not be described in more detail.

In this preferred embodiment, in reference to FIG. 3, the first gear line L1 comprises three pinions P₁₁, P₁₂, P₁₃ that are associated in series such that the toothing of the first pinion P₁₁ meshes with the toothing of the second pinion P₁₂, which in turn meshes with the third pinion P₁₃.

Preferably, in reference to FIG. 3, the electric motor M4(M) of the auxiliary electric drive module M4 is placed behind the coupling unit 4, while the electric battery M4(B) of the auxiliary electric drive module M4 is placed in front of the coupling unit 4. Such a configuration makes it possible to increase the compactness of the drive device 3. The hydraulic drive module M1 and the auxiliary electric motor M4(M) are connected to the first pinion P₁₁ of the first gear line L1.

Since the hydraulic drive module M1 and the auxiliary electric motor M4(M) are connected to a same pinion P₁₁ of the same gear line L1, there is a direct connection between the two drive modules M1, M4, which on the one hand facilitates recharging of the hydraulic drive module M1 by the auxiliary electric drive module M4, and on the other hand facilitates recharging of the auxiliary electric drive module M4 by the hydraulic drive module M1.

In particular, during braking of the transportation bus 1, the recovered kinetic energy is shared between the hydraulic drive module M1, the primary electric drive module M3 and the auxiliary electric drive module M4.

The third pinion P₁₃ of the first gear line L1 is suitable for being coupled to the second gear line L2, as will be detailed below.

The second pinion P₁₂ of the first gear line L1 is an intermediate pinion suitable for connecting the first pinion P₁₁ to the third pinion P₁₃. Such an intermediate pinion makes it possible to increase the space between the two pinions P₁₁, P₁₃ and thus to increase the available space for the hydraulic drive module M1 and the auxiliary electric drive module M4 with respect to the second gear line L2 and the primary electric drive module M3. In the example of FIG. 2, the pinions P₁₁, P₁₂, P₁₃ of the first gear line L1 respectively have diameters of 22 cm, 18 cm and 22 cm.

Of course, the first gear line L1 could comprise only two pinions P₁₁, P₁₃. In this case, the pinions P₁₁, P₁₃ should have a large diameter to allow side-by-side positioning of the hydraulic drive module M1 and the primary electric motor M3(M) in front of the coupling unit 4 as illustrated in FIG. 3.

Still in reference to FIG. 3, the second gear line L2 in turn comprises a first pinion P₂₁ and a second pinion P₂₂. The first pinion P₂₁ of the second gear line L2 is suitable for being connected to the first gear line L1, as will be described later.

The primary electric motor M3(M) is connected to the first pinion P₂₁ of the second gear line L2. In this embodiment, the primary electric motor M3(M) is placed in front of the coupling unit 4, i.e., on the same side as the hydraulic drive module M1.

The second pinion P₂₂ of the second gear line L2 is in turn connected to the output shaft 5 in order to transmit the torque received by the first pinion P₂₁ to the rear wheels 2B via the gearbox 6.

The coupling unit 4 makes it possible to associate the different energies of the drive modules M1, M3 and M4 in order to provide appropriate torque to the output shaft 5 while optimizing the energy recovery, in particular during the braking of the transportation bus 1.

Still in reference to FIG. 3, coupling unit 4 comprises a connecting element 8 suitable for securing the third pinion P₁₃ of the first gear line L1 in rotation with the first pinion P₂₁ of the second gear line L2. In this example, the connecting element 8 assumes the form of a clutch, but of course other types of connection may be appropriate, for example a speed synchronization device known by those skilled in the art as “synchronous”, which comprises a dog element and a sliding element.

When the connecting element 8 is activated, the gear lines L1, L2 are connected together, which allows the drive modules M1, M4 to participate in driving the output shaft 5 and/or to receive torque from said output shaft 5.

Of course, the drive device 3 could comprise other drive modules, for example a kinetic energy drive module such as a flywheel.

### Example Embodiments

Several embodiments of the invention will now be described in order to illustrate the operation of the drive device 3.

As an example, the transportation bus 1 starts up owing to the primary electric drive module M3 with assistance provided by the hydraulic drive module M1. After increasing the speed, the primary electric drive module M3 alone provides the torque to the output shaft 5. The connecting element 8 is deactivated, and only the second gear line L2 drives the output shaft 5. To reach a high speed, the primary electric drive module M3 is assisted by the hydraulic drive module M1, which in turn is assisted by the thermal drive module M2.

The thermal drive module M2 makes it possible to recharge the hydraulic drive module M1 directly via its hydrostatic link 7 without passing through a pinion of the coupling unit 4. This recharging is done by disengaging the first gear line L1 from the second gear line L2. In this example embodiment, the thermal drive module M2 cannot recharge the primary electric drive module M3.

In other words, the thermal drive module M2 behaves like an auxiliary power source suitable for meeting the needs of the hydraulic drive module M1. By analogy with the aeronautic field, the thermal drive module M2 can perform a support function similar to that of an auxiliary power device known by those skilled in the aeronautic field under the name APU (Auxiliary Power Unit). Likewise, the thermal drive module M2 can perform an autonomy extending function, known by those skilled in the art as a “range extender”.

The auxiliary electric drive module M4 is suitable for powering auxiliary members of the transportation bus 1, for example the air-conditioning motor. Furthermore, it is suitable for recharging the hydraulic drive module M1 if needed. Such recharging has a high performance, given that the auxiliary electric drive module M4 and the hydraulic drive module M1 are connected to a same pinion P₁₁ of the first gear line L1.

Owing to the invention, a drive device is obtained that is compact, has a simple design and offers great reliability. Furthermore, in case of failure of one of the drive modules, the auxiliary energy storage body 12 allows a quick replacement of said modules, which guarantees increased availability of the transportation bus 1.

1. A drive device for a transportation motor vehicle comprising at least one hydraulic drive module and one primary electric drive module, a coupling unit and an output shaft that is suitable for being driven by the hydraulic drive module and/or the primary electric drive module via said coupling unit, the hydraulic drive module and the primary electric drive module being directly connected to said coupling unit, the drive device further comprising a backup energy module directly connected to the hydraulic motor module, and wherein the coupling unit comprises a first gear line, a second gear line, connected to the output shaft, and a connecting means for associating the two gear lines.

2. The device according to claim 1, wherein the backup energy module is connected to the hydraulic drive module by a hydrostatic link.

3. The device according to claim 1, wherein each gear line comprises a plurality of pinions.

4. The device according to claim 1, wherein the hydraulic drive module is connected to the first gear line and the primary electric drive module is connected to the second gear line.

5. The device according to claim 1, wherein the drive device comprises an auxiliary electric drive module, connected to the first gear line.

6. The device according to claim 5, wherein the auxiliary electric drive module and hydraulic drive module are connected to a same pinion of the first gear line.

7. The device according to claim 5, wherein, the auxiliary electric drive module comprising a generator, the hydraulic drive module is configured to drive said generator.

8. The device according to claim 1, wherein the energy supply module is a thermal drive module.

9. A motor vehicle, preferably of the bus type, comprising at least one set of wheels and a drive device according to claim 1 to drive said set of wheels.
